(19) United States
(12) Patent Application Publication
(10) Pub. No.: US 2003/0217055 A1
(43) Pub. Date: Nov. 20, 2003

(54) Efficient incremental method for data mining of a database

(76) Inventors: Chang-Huang Lee, Taipei (TW); Ming-Syan Chen, Taipei (TW)

Correspondence Address: J.C. Patents, Inc., Suite 250, 4 Venture, Irvine, CA, 92618, US

(21) Appl. No.: 10/153,017

(22) Filed: May 20, 2002

(51) Int. Cl. G06F 17/30

(52) U.S. Cl. 707/6

(57) ABSTRACT

A method for discovering association rules in an electronic database commonly known as data mining. A database is divided into a plurality of sections, and each section is sequentially scanned, the results of the previous scan being taken into consideration in a current scanned partition. Three algorithms are further developed on this basis that deal with incremental mining, mining general temporal association rules, and weighted association rules in a time-variant database.

### BACKGROUND OF INVENTION

1. Field of the Invention

The present invention relates to efficient techniques for the data mining of the information databases.

2. Description of Related Art

The ability to collect huge amounts of data, and the low cost of computing power has given rise to enhanced automatic analysis of this data referred to as data mining. The discovery of association relationships within the databases is useful in selective marketing, decision analysis, and business management. A popular area of applications is the market basket analysis, which studies the buying behaviors of customers by searching for sets of items that are frequently purchased together or in sequence. Typically, the process of data mining is user controlled through thresholds, support and confidence parameters, or other guides to the data mining process. Many of the methods for mining large databases were introduced in “Mining Association Rules between Sets of Items in Large Databases,” R. Agrawal and R. Srikant (Proc. 1993 ACM SIGMOD Intl. Conf on Management of Data, pp. 207-216, Wash., D.C., May 1993.). In that paper, it was shown that the problem of mining association rules is composed of the following two subproblems: discovering the frequent itemsets, i.e., all sets of itemsets that have transaction support above a pre-determined minimum support s, and using the frequent itemsets to generate the association rules for the database. The overall performance of mining association rules is in fact determined by the first subproblem. After the frequent itemsets are identified, the corresponding association rules can be derived in a straightforward manner. Previous algorithms include Apriori (R. Agrawal, T. Imileinski, and A. Swani. Mining association Rules between Sets of Items in Large Databases. Proc. Of ACM SIGMOD, pages 207-216, May 1993), TreeProjection (R. Agarwal, C. Aggarwal, and VVV Prasad. A Tree Projection Algorithm for Generation of Frequent Itemsets. Journal of Parallel and Distributed Computing (Special Issue on High Performance Data Mining), 2000.), and FP-tree (J. Han, J. Pei, B. Mortazavi-Asl, Q. Chen, U. Dayal, and M.-C. Hsu. FreeSpan: Frequent pattern projected sequential pattern mining. Proc. Of 2000 Int. Conf on Knowledge Discovery and Data Mining, pages 355-359, August 2000.).

To better understand the invention, a brief overview of typical association rules and their derivation is provided. Let I={x₁, x₂, . . . , xₘ} be a set of items. As set X⊂I with k=|X| is called a k-itemset or simply an itemset. Let a database D be a set of transactions, where each transaction T is a set of items such that X⊂I. A transaction T is said to support X if and only if X⊂I. Conventionally, an association rule is an implication of the form X [symbol] Y, meaning that the presence of the set X implies the presence of another set Y where X⊂I, Y⊂I, and X∩Y=φ. The rule X [symbol] Y holds in the transaction set D with confidence c if c% of transactions in D that contain X also contain Y The rule X [symbol] Y has support s in the transaction set D if s% of transactions in D contain X∪Y.

For a given pair of confidence and support thresholds, the problem of mining association rules is to identify all association rules that have confidence and support greater than the corresponding minimum support threshold (denoted as s) and minimum confidence threshold (denoted as min_conf). Association rule mining algorithms work in two steps: generate all frequent itemsets that satisfy s, and generate all association rules that satisfy min_conf using the frequent itemsets. This problem can be reduced to the problem of finding all frequent itemsets for the same support threshold. As mentioned a broad variety of efficient algorithms for mining association rules have been developed in recent years including algorithms based on the level-wise Apriori framework, TreeProjection, and FP-growth algorithms. However these algorithms still in many cases have high processing times leading to increased I/O and CPU costs, and cannot effectively be applied to the mining of a publication-like database which is of increasing popularity. An FUP algorithm updates the association rules in a database when new transactions are added to the database. Algorithm FUP is based on the framework of Apriori and is designed to discover the new frequent itemsets iteratively. The idea is to store the counts of all the frequent itemsets found in a previous mining operation. Using these stored counts and examining the newly added transactions, the overall count of these candidate itemsets are then obtained by scanning the original database. An extension to the work in FUP₂ for updating the existing association rules when transactions are added to and deleted from the database. In essence, FUP₂ is equivalent to FUP for the case of insertion, and is, however, a complementary algorithm of FUP for the case of deletion. It is shown that FUP₂ outperforms Apriori algorithm which, without many provision for incremental mining, has to re-run the association rule mining algorithm on the whole updated database. Another FUP-base algorithm, called FUP₂H was also devised to utilize the hash technique for performance improvement. Furthermore, the concept of negative borders and that of UWEP, i.e. update with early pruning, are utilized to enhance the efficiency of FUP-based algorithms. However, as will be shown by our experimental results the above mentioned FUP-based algorithms tend to suffer from two inherent problems, namely the occurrence of a potentially huge set of candidate itemsets, and the need for multiple scans of database. First, consider the problem of a potentially huge set of candidate itemsets. Note that the FUP-based algorithms deal with the combination of two sets of candidate itemsets which are independently generated, i.e., from the original data set and the incremental data subset. Since the set of candidate itemsets includes all the possible permutations of the elements, FUP-based algorithms may suffer from a very large set of candidate itemsets, especially from candidate 2-itemsets. This problem becomes even more severe for FUP-based algorithms when the incremented portion of the incremental mining is large. More importantly, in many applications, one may encounter new itemsets in the incremented dataset. While adding some new products in the transaction database, FUP-based algorithms in the worst case. That is, the case of k=8 means that the database has to be scanned 8 times, which is very costly, especially is terms of I/O cost. As will become clear later, the problem of a large set of candidate itemsets will hinder an effective use of the scan reduction technique by an FUP-based algorithm.

The prior algorithms have many limitations when mining a publication database as shown in FIG. 1. In essence, a publication database is a set of transactions where each transaction T is a set of items of which each item contains an individual exhibition period. The current model of association rule mining is not able to handle the publication database due to the following fundamental problems: lack of consideration of the exhibition period of each individual item, and lack of equitable support counting basis for each item.

In considering the example transaction database in FIG. 2 we see a further limitation of the prior art. Note that db^{i,j} is the part of the transaction database formed by a continuous region from partition Pₗ to partition Pⱼ. Suppose we have conducted the mining for the transaction database db^{l,j}. As time advances, we are given the new data of January of 2001, and are interested in conducting an incremental mining against the new data. Instead of taking all the past data into consideration, our interest is limited to mining the data in the last 12 months. As a result, the mining of the transaction database db^{l+l,j+1} is called for. Note that since the underlying transaction database has been changed as time advances, some algorithms, such as Apriori, may have to resort to the regeneration of candidate itemsets for the determination of new frequent itemsets, which is, however, very costly even if the incremental data subset is small. On the other hand, FP-tree-based mining methods are likely to suffer from serious memory overhead problems since a portion of database is dept in main memory during their execution. While FP-tree-based methods are shown to be efficient for small databases, it is expected that such a deficiency of memory overhead will become even more severe in the presence of a large database upon which an incremental mining process is usually performed.

A time-variant database as shown in FIG. 3, consists of values or events varying with time. Time-variant databases are popular in many application, such as daily fluctuations of a stock market, traces of a dynamic production process, scientific experiments, medical treatments, weather records, to name a few. The existing model of the constraint-based association rule mining is not able to efficiently handle the time-variant database due to two fundamental problems, i.e., (1) lack of consideration of the exhibition period of each individual transaction; (2) lack of an intelligent support counting basis for each item. Note that the traditional mining process treats transactions in different time periods indifferently and handles them along the same procedure. However, since different transactions have different exhibition periods in a time-variant database, only considering the occurrence count of each item might not lead to interesting mining results.

Therefore, a need exists for a data mining methods that address the limitations of the prior methods as described hereinabove.

### SUMMARY OF THE INVENTION

These and other features, which characterize the invention, are set forth in the claims annexed hereto and forming a further part hereof However, for a better understanding of the invention, and of the advantages and objectives attained through its use, reference should be made to the drawings, and to the accompanying descriptive matter, in which there is described exemplary embodiments of the invention.

It is one object of the invention to provide a pre-processing algorithm with cumulative filtering and scan reduction techniques to reduce I/O and CPU costs.

It is also an object of the invention to provide an algorithm with effective partitioning of a data space for efficient memory utilization.

It is a further object of the invention for provide an algorithm for efficient incremental mining for an ongoing time-variant transaction database.

It is another object of the invention to provide an algorithm for the efficient mining of a publication-like transaction database.

It is yet a further object of the invention to provide an algorithm for with weighted association rules for a time-variant database.

A pre-processing algorithm forms the basis of this disclosure. A database is divided into a plurality of partitions. Each partition is then scanned for 2-itemset candidates. In addition, each potential candidate itemset is given two attributes: c.start which contains the partition number of the corresponding starting partition when the itemset was added to an accumulator, and c.count which contains the number of occurrences of the itemset since the itemset was added to the accumulator. A partial minimal support is then developed called the filtering threshold. Itemsets whose occurrence is below the filtering threshold are removed. The remaining candidate itemsets are then carried over to the next phase for processing. This pre-processing algorithm forms the basis for the following three algorithms.

To deal with the mining of general temporal association rules, an efficient first algorithm is devised. The basic idea of the first algorithm is to first partition a publication database in light of exhibition periods of items and then progressively accumulate the occurrence count of each candidate 2-itemset based on the intrinsic partitioning characteristics. The algorithm is also designed to employ a filtering threshold in each partition to early prune out those cumulatively infrequent 2-itemsets.

A second algorithm is further disclosed for incremental mining of association rules. In essence, by partitioning a transaction database into several partitions, and employs a filtering threshold in each partition to deal with the candidate itemset generation. In the second algorithm the cumulative information in the prior phases is selectively carried over towards the generation of candidate itemsets in the subsequent phases. After the processing of a phase, the algorithm outputs a cumulative filter, denoted by DF, which consists of a progressive candidate set of itemsets, their occurrence counts and the corresponding partial support required. The cumulative filter as produced in each processing phase constitutes the key component to realize the incremental mining.

The third algorithm performs mining in a time-variant database. The importance of each transaction period is first reflected by a proper weight assigned by the user. Then the algorithm partitions the time-variant database in light of weighted periods of transactions and performs weighted mining. The algorithm is designed to progressively accumulate the itemset counts based on the intrinsic partitioning characteristics and employ a filtering threshold in each partition to early prune out those cumulatively infrequent 2-itemsets. With this design, the algorithm is able to efficiently produce weighted association rules for applications where different time periods are assigned with different weights and lead to results of more interest.

### BRIEF DESCRIPTION OF DRAWINGS

FIG. 1 shows an illustrative publication database

FIG. 2 shows an ongoing time-variant transaction database

FIG. 3 shows a time-variant transaction database

FIG. 4 shows a block diagram of a data mining system

FIG. 5 shows an illustrative transaction database and corresponding item information

FIGS. 6a-c show frequent temporal itemsets generation for mining general temporal association rules with the first algorithm

FIG. 7 shows a flowchart for the first algorithm

FIG. 8 shows the second illustrative transaction database

FIG. 9a-b show large itemsets generation for the incremental mining with the second algorithm

FIG. 10 shows a flowchart for the second algorithm

FIG. 11 shows the third illustrative database

FIGS. 12a-c show the generation of frequent itemsets using the third algorithm

FIG. 13 shows a flowchart for the third algorithm

### DETAILED DESCRIPTION

In the following detailed description of the preferred embodiments, reference is made to the accompanying drawings which form a part hereof, and in which is shown by way of illustration specific preferred embodiments in which the invention may be practiced. The preferred embodiments are described in sufficient detail to enable these skilled in the art to practice the invention, and it is to be understood that other embodiments may be utilized and that logical, changes may be made without departing from the spirit and scope of the present invention. The following detailed description is, therefore, not to be taken in a limiting sense, and the scope of the present invention is defined only be the appended claims.

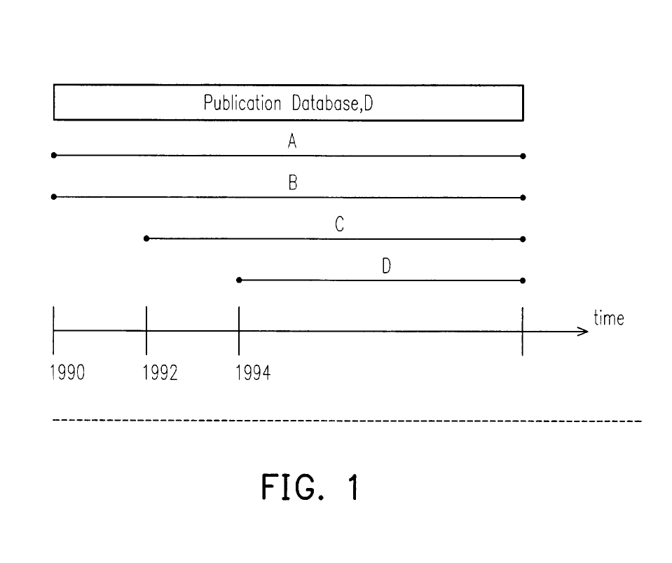

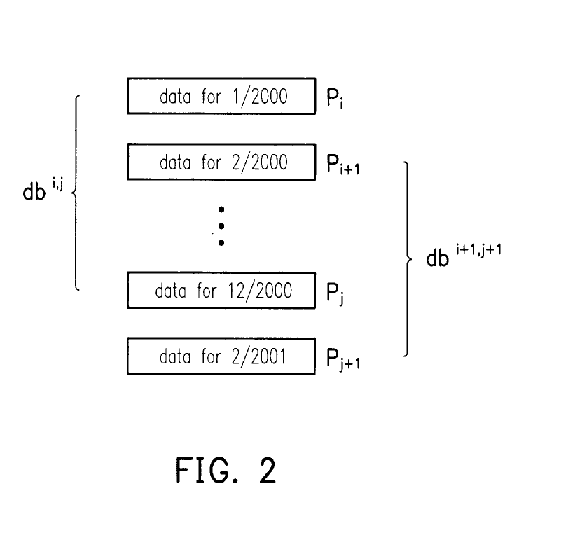

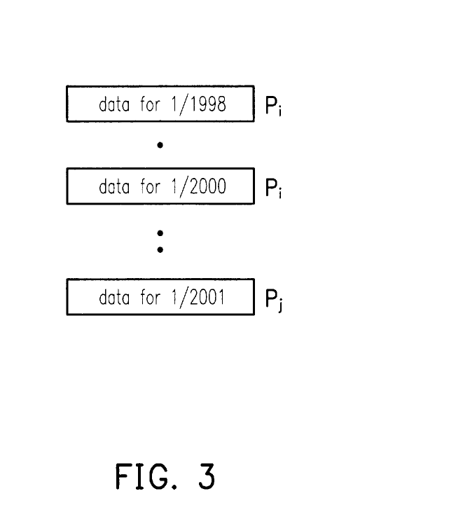

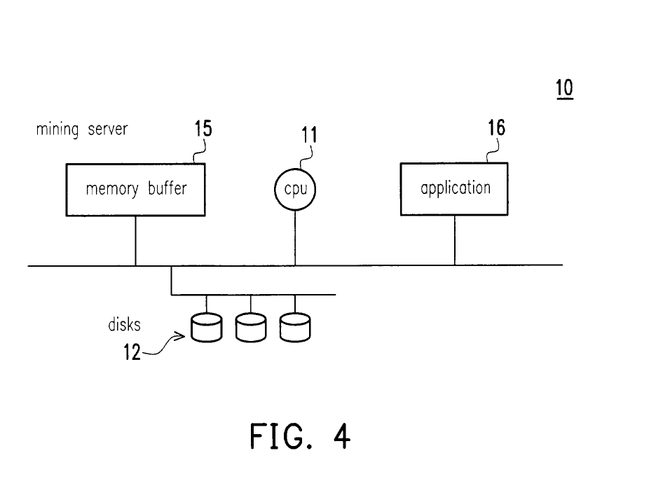

The present invention relates to an algorithm for data mining. The invention is implemented in a computer system of the type as illustrated in FIG. 1. The computer system 10 consists of a CPU 11, and plurality of storage disks 12, a memory buffer 15, and application software 16. Processor 11 applies the data mining algorithm application 16 to information retrieved from the permanent storage locations 12, using memory buffers 15 to store the data in the process. While data storage is illustrated as originating from the storage disks 12, the data can alternatively come from other sources such as the internet.

A pre-processing algorithm is presented that forms the basis of three later algorithms: the first algorithm to discover general temporal association rules in a publication database, the second for the incremental mining of association rules, and the third algorithm for time-constraint mining on a time-variant database. The pre-processing algorithm operates by segmenting a database into a plurality of partitions. Each partition is then scanned sequentially for the generation of candidate 2-itemsets in the first scan of the database. In addition, each potential candidate itemset C∈C₂ has two attributes c.start which contains the identity of the starting partition when c was added to C₂, and c.count which contains the number of occurrences of c since c was added to C₂. A filtering threshold is then developed and itemsets whose occurrence counts are below the filtering threshold are removed. The remaining candidate itemsets are then carried over to the next phase of processing. After generating C₂ from the first scan of database db^{1,3}, we employ the scan reduction technique and use C₂ to generate Cₖ (k=2, 3, . . . , m), where Cₘ is the candidate last-itemsets. Clearly a C₃′ generated from C₂*C₂, instead of from L₂*L₂, will have a size greater than |C₃| where C₃ is generated from L₂*L₂. However, since the |C₂| generated by the algorithm is very close to the theoretical minimum, i.e., |L₂|, the |C₃′| is not much larger than |C₃|. Similarly, the |Cₖ′| is close to |Cₖ|. All Cₖ′ can be stored in main memory, and we can find Lₖ (k=1, 2, . . . , n) together when the second scan of the database db^{1,3} is performed. Thus only two scans of the original database db^{1,3} are required in the preprocessing step. An example of algorithm is shown below (which forms the basis of the next three described algorithms):

db^{1,n}=The partial database of D formed by a continuous region from Pₗ to Pₙ

I=itemset

s=minimum support required

n=number of partitions;

CF=cumulative filter

P=partition

C=set of progressive candidate itemsets generated by database db^{l,j}

L=determined frequent itemset

$$1. \vert {db}^{1 , n} \vert = {\sum }_{k = 1 , n}^{} \vert {P}_{k} \vert ;$$

2. CF=0;

3. begin for k=1 to n //1^{st} scan of db^{1,n}

4. begin for each 2-itemset I∈Pₖ

5. if (I∉CF)

6. I.count=Nₚₖ(I);

7. I.start=k;

8. if (I.count≧s*|Pₖ|)

9. CF=CF∪I;

10. if (I∈CF)

11. I.count=I.count+Nₚₖ(I);

12.

$$if ( I . count < ⌈ s * {\sum }_{m = I . start , k}^{} \vert {P}_{m} \vert ⌉ )$$

13. CF=CF−I;

14. end

15. end

16. select C₂ from I where I∈CF

17. begin while (Cₖ≠0)

18. Cₖ₊₁=Cₖ*Cₖ

19. k=k+1;

20. end

21. begin for k=1 to n //2^{nd} scan of db^{1,n}

22. for each itemset I∈Cₖ

23. I.count=I.count+Nₚₖ(I);

24. end

25. for each itemset I∈Cₖ

26. if (I.count≧┌s*|db^{1,n}|┐)

27. Lₖ=Lₖ∪I;

28. end

This pre-processing algorithm forms the basis of the following three algorithms.

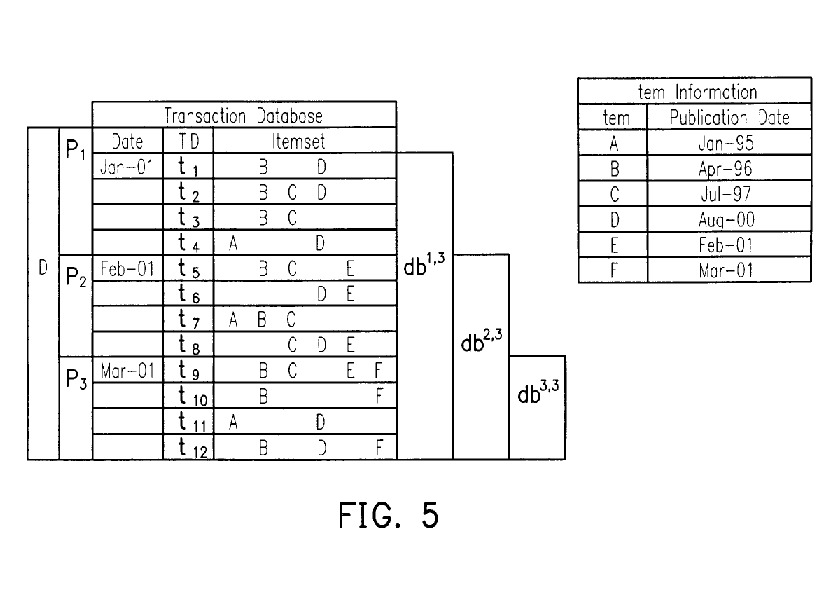

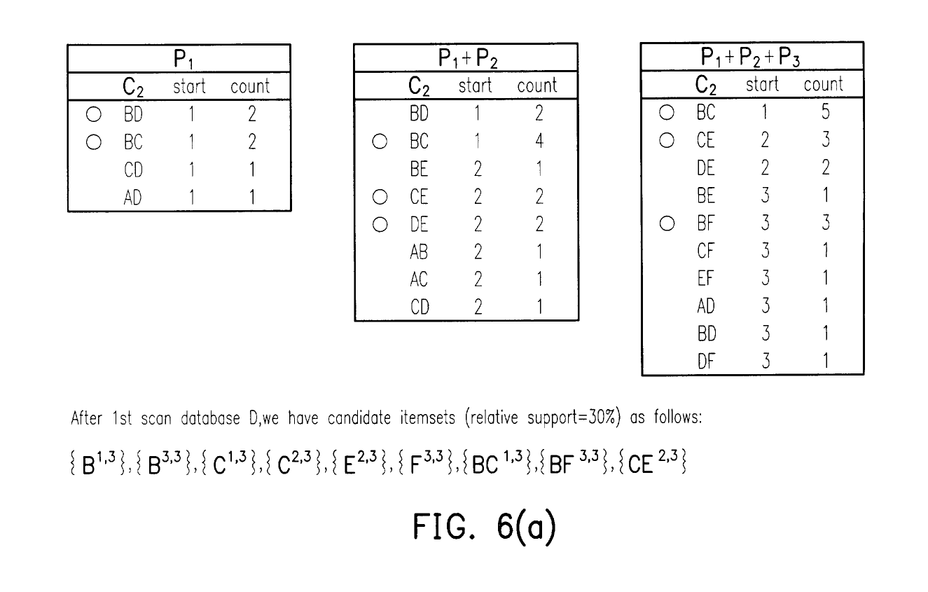

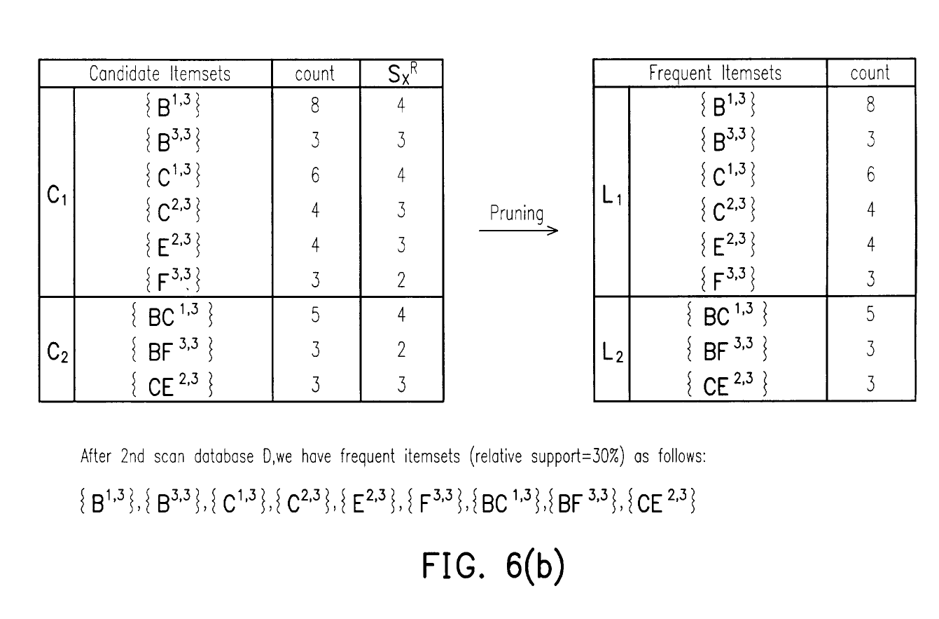

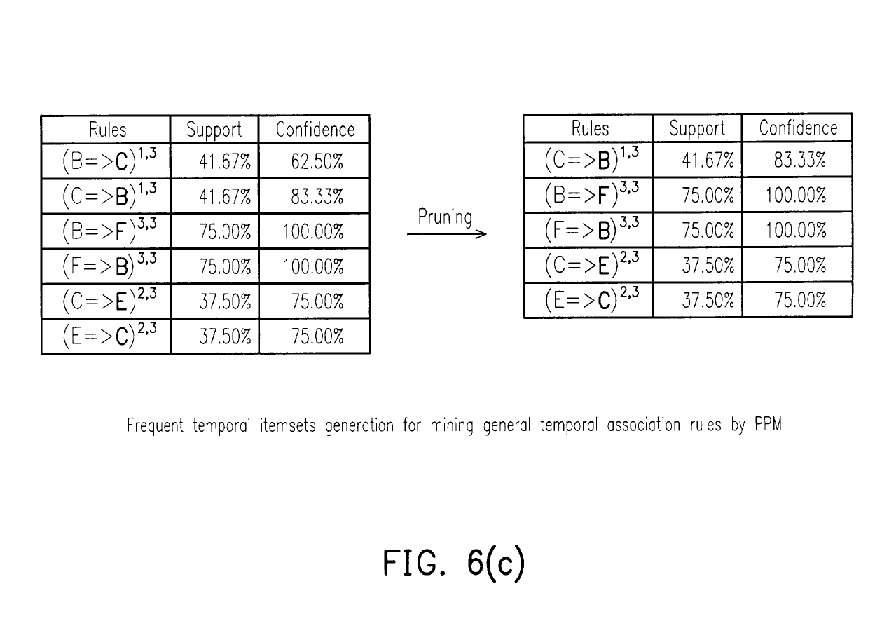

In order to discover general temporal association rules in a publication database, the first algorithm is used. In essence, a publication database is a set of transactions where each transaction T is a set of items of which each item contains an individual exhibition period. The current model of association rule mining is not able to handle the publication database due to the following fundamental problems, i.e., lack of consideration of the exhibition period of each individual item. A transaction database as shown in FIG. 5 where the transaction database db^{1,3} is assumed to be segmented into three partitions P₁, P₂, P₃, which correspond to the three time granularities from January 2001 to March 2001. Suppose that min_supp=30% and min_conf=75%. Each partition is scanned sequentially for the generation of candidate 2-itemsets in the first scan of the database db^{1,3}. After scanning the first segment of 4 transactions, i.e., partition P₁, 2-itemsets {BD, BC, CD, AD} are sequentially generated as shown in FIG. 6a. In addition, each potential candidate itemset c∈C₂ has two attributes (1) c.start which contains the partition number of the corresponding starting partition when c was added to C₂, and (2) c.count which contains the number of occurrences of c since c was added to C₂. Since there are four transactions in P₁, the partial minimal support is ┌4*0.3┐=2. Such a partial minimal support is called the filtering threshold. Itemsets whose occurrence counts are below the filtering threshold are removed. Then, as shown in FIG. 6a, only {BD,BC}, marked by “O”, remain as candidate itemsets (of type β in this phase since they are newly generated) whose information is then carried over to the next phase P₂ of processing. Similarly, after scanning partition P₂, the occurrence counts of potential candidate 2-itemsets are recorded (of type α and type β). From FIG. 6a, it is noted that since there are also 4 transactions in P₂, the filtering threshold of those itemsets carried out from the previous phase (that become type α candidate itemsets in this phase) is ┌(4+4)*0.3┐=3 and that of newly identified candidate itemsets (i.e., type β candidate itemsets) is ┌4*0.3┐=2. It can be seen that we have 3 candidate itemsets in C₂ after the processing of partition P₂, and one of them is of type α and two of them are of type β. Finally, partition P₃ is processed by the first algorithm. The resulting candidate 2-itemsets are C₂={BC, CE, BF} as shown in FIG. 6b. Note that though appearing in the previous phase P₂, itemset {DE} is removed from C₂ once P₃ is taken into account since its occurrence count does not meet the filtering threshold then, i.e. 2<3. However, we do have one new itemset, i.e. BF, which joins the C₂ as a type β candidate itemset. Consequently, we have 3 candidate 2-itemsets generated by PPM, and two of them of type α and one of them is type β. Note that only 3 candidate 2-itemsets are generated by the first algorithm. After generating C₂ from the first scan of database db^{1,3}, we employ the scan reduction technique [26] and use C₂ to generate Cₖ (k=2, 3, . . . , m), where Cₘ is the candidate last-itemsets. Instead of generating C₃ from L₂*L₂, a C₂ generated by the algorithm can be used to generate the candidate 3-itemsets and its sequential

$${C}_{k - 1}^{′}$$

can be utilized to generate

$${C}_{k}^{′} .$$

Clearly, a C₃′ generated from C₂*C₂, instead of from L₂*L₂, will have a greater than |C₃| where C₃ is generated from L₂*L₂. However, since the |C₂| generated by first algorithm is very close to the theoretical minimum, i.e. |L₂|, the |C₃′| not much larger than |C₃|. Similarly, the |Cₖ′| is close to |Cₖ|. Since C₂={BC, CE, BF}, no candidate k-itemset is generated in this example where k≧3. Thus Cₖ′={BC, CE, BF} are termed to be the candidate maximal temporal itemsets (TIs), i.e. BC^{1,3}, CE^{2,3}, CE^{3,3}, with a maximum exhibition period of each candidate.

Before we preprocess the second scan of the database db^{1,3} to generate L_{kS}, all candidate SIs of candidate TIs can be propagated, and then added into Cₖ′. For instance, as shown in FIG. 6c, both candidate l-itemsets B^{1,3}, and C^{1,3} are derived from BC^{1,3}. Moreover, since BC^{1,3}, for example, is a candidate 2-itemset, its subsets, i.e. B^{1,3}, and C^{1,3} are derived from B^{1,3}. Moreover, since BC^{1,3}, for example, is a candidate 2-itemset, its subsets, i.e., B^{1,3} and C^{1,3}, should potentially be candidate itemsets. As a result 9 candidate itemsets, i.e. (B^{1,3}, B^{3,3}, C^{1,3}, C^{2,3}, E^{2,3}, and F^{3,3} are frequent SIs in this example. As shown in FIG. 6c, after all frequent TI and SI itemsets are identified, the corresponding general temporal association rules can be derived in a straightforward manner. Explicitly, the general temporal association rule of (X [symbol] Y)^{1,n} holds if conf ((X [symbol] Y)^{1,n})>min_conf.

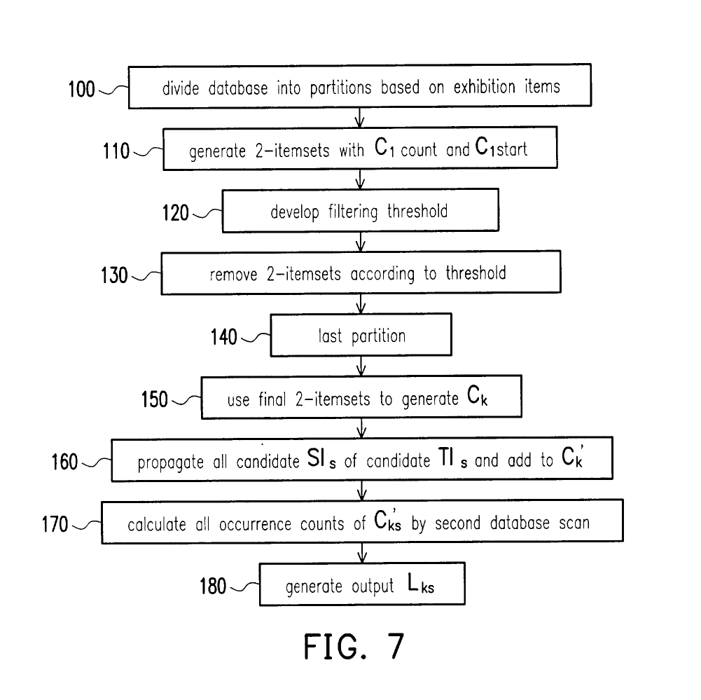

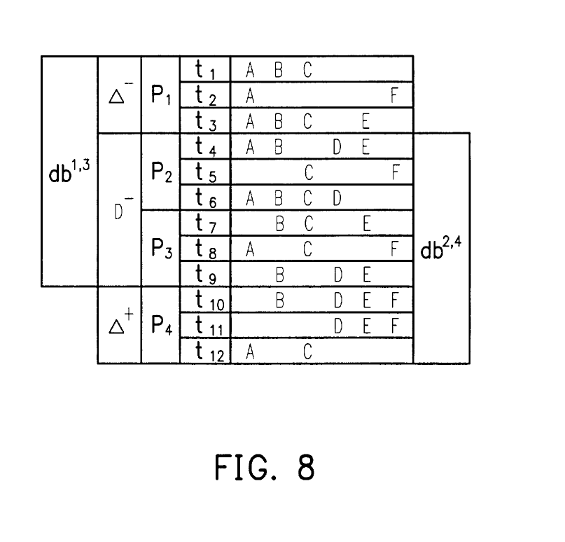

If we let n be the number of partitions with a time granularity, e.g. business-week, month, quarter, year, to name a few, in database D. In the model considered, db^{1,n} denotes the part of the transaction database formed by a continuous region from partition Pₜ to partition Pₙ, and

$$\vert {db}^{t . n} \vert = {\sum }_{h = t , n}^{} \vert {P}_{h} \vert$$

where db^{t,n}⊂D. An item X^{x start,n} is termed as a temporal item of x, meaning that P_{x start} is the starting partition of x and n is the partition number of the last database partition retrieved. Again consider the database in FIG. 5. Since database D records the transaction data from January 2001 to March 2001, database D is intrinsically segmented into three partitions P₁, P₂, and P₃ in accordance with the “month” granularity. As a consequence, a partial database db^{2,3}⊂D consists of partitions P₂ and P₃. A temporal item E^{2,3} denotes that the exhibition period of E^{2,3} is from the beginning time of partition P₂ to the end time of partition P₃. An itemset X^{t,n} is called a maximal temporal itemset in a partial database db^{t,n} if t is the latest starting partition number of all items belonging to X in database D and n is the partition number of the last partition in db^{t,n} retrieved. In addition let N_{db}_{^{t,n}}(X^{t,n}) be the number of transactions in partial database db^{t,n} that contain itemset X^{t,n}, and |db^{t,n}| is the number of transactions in the partial database db^{t,n}. FIG. 7 shows a flowchart demonstrating the first algorithm which is further outlined below, where the first algorithm is decomposed into five sub-procedures for ease of description.

Initial Sub-procedure: The database D is partitioned into n partitions and set CF=0

db^{1,n}=The partial database of D formed by a continuous region from Pₗ to Pₙ

|db^{1,n}=number of transactions in db^{i,n}

X^{1,n}=A temporal itemset in partial database db^{1,n}

MCP(X^{t,n})=(t,n) The maximal common exhibition period of an itemset X

(x [symbol] Y)^{t,n}=A general temporal association rule in db^{t,n}

supp((X [symbol] Y)^{t,n})=The support of X [symbol] Y in partial database db^{t,n}

conf((X [symbol] Y)^{t,n})=The support of X [symbol] Y in partial database db^{t,n}

s=Minimum support threshold required

min_leng=Minimum length of exhibition period required

TI=A maximal temporal itemset

SI=A corresponding temporal sub-itemset of TI

n=Number of partitions;

CF=cumulative filter

P=partition

C=set of progressive candidate itemsets generated by database db^{l,j}

L=determined frequent itemset

$$1. \vert {db}^{1 , n} \vert = {\sum }_{k = 1 , n}^{} \vert {P}_{k} \vert ;$$

2. CF=0;

3. begin for k=1 to n //1^{st} scan of db^{1,n}

4. begin for each 2-itemset

$${X}_{2}^{t , n} ∈ {P}_{k}$$

where n−t>min_leng

5. if (X₂∈CF)

6. X₂.count=Nₚₖ(I);

7. X₂.start=k;

8. if (X₂.Count≧s*|Pₖ|)

9. CF=CF∪X₂;

10. if (X₂∈CF)

11. X₂.count=X₂.count+Nₚₖ(X₂);

$$12. if ( {X}_{2} . count < ⌈ s * {\sum }_{m = {X}_{2} start , k}^{} \vert {P}_{m} \vert ⌉ )$$

13. CF=CF−X₂;

14. end

15. end

16. select C₂ from X₂ where X₂∈PS;

17. CF=0

Sub-procedure II: Generate candidate TIs and SIs with the scheme of database scan reduction

18. begin while (Cₖ≠0 & k≧2)

19. Cₖ₊₁=Cₖ*Cₖ;

20. k=k+1;

21. end

$$22. {X}_{k}^{t , n} = \{ {X}_{k}^{t , n} ⊆ {X}_{k} \vert {X}_{k} ∈ {C}_{k} \} ;$$

//Candidate TIs generation

$$23. SI ( {X}_{k}^{t , n} ) = \{ {X}_{k}^{t , n} ⊆ subset of {X}_{k}^{t , n} \vert j < k \} ;$$

//Candidate SIs of TIs generation

$$24. CF = CF ⋃ SI ( {X}_{k}^{t , n} ) ; \\ 25. Select {X}_{k}^{t , n} into {C}_{k} where {X}_{k}^{t , n} ∈ PS ;$$

Sub-procedure III: Generate all frequent TIs and Sis with the 2^{nd} scan of database D

26. Begin for k=1 to n

$$27. For each itemset {X}_{k}^{t , n} ∈ {C}_{k}$$

$$28. {X}_{k}^{t , n} \cdot count = {X}_{k}^{t , n} \cdot count + {N}_{p h} ( {X}_{k}^{t , n} ) ;$$

29. end

30. for each itemset

$${X}_{k}^{t , n} ∈ {C}_{k}$$

$$31. if ( {X}_{k}^{t , n} \cdot count \geq ⌈ min\_sup {p}^{*} \vert ⅆ {b}^{t , n} \vert ⌉ )$$

$$32. {L}_{k} = {L}_{k} ⋃ {X}_{k}^{t , n} ;$$

33. end

Sub-procedure IV: Prune out the redundant frequent Sis from Lₖ

34. for each SI itemset

$${X}_{k}^{t , n} ∈ {L}_{k}$$

35. If (does not exist

$${TIX}_{j}^{t , n} ⊆ {L}_{j} \vert j > k )$$

36.

$${L}_{k} = {L}_{k} - {X}_{k}^{t , n} ;$$

37. end

38. return Lₖ;

In essence, Sub-procedure 1 first scans partition p₁ for i=1 to n, to find the set of all local frequent 2-itemsets in p₁. Note that CF is a superset of the set of all frequent 2-itemsets in D. The first algorithm constructs CF incrementally by adding candidate 2-itemset to CF and starts counting the number of occurrences for each candidate 2-itemset X₂ in CF whenever X₂ is added to CF. If the cumulative occurrences of a candidate 2-itemset X₂ does not meet the partial minimum support required, X₂ is removed from the progressive screen CF. From step 3 to step 15 of sub-procedure 1, the first algorithm processes one partition at a time for all partitions. When processing partition Pₗ, each potential candidate 2-itemset X₂ is read and saved to CF where its exhibition period, i.e., n−t, should be larger than the minimum constraint exhibition period min_leng required. The number of occurrences of an itemset X₂ and its starting partition which keeps it first occurrence in CF are recorded in X₂.count and X₂.start respectively. As such, in the end of processing db^{1,h}, only an itemset, whose X₂.count≧

$$⌈ s * {\sum }_{m = 1 start , h} \vert {P}_{m} \vert ⌉ ,$$

will be kept in CF. Note that a large amount of infrequent TI candidates will be further reduced with the early pruning technique by this progressive portioning processing. Next, in Step 16 we select C₂ from X₂∈CF and set CF=0 in Step 17.

In sub-procedure II, with the scan reduction scheme [26], C₂ produced by the first scan of database is employed to generate C_{kS} (k≧3) in main memory from step 18 to step 21. Recall that Xₖ^{t,n} is a maximal temporal k-itemset in a partial database db^{t,n}. In Step 22, all candidate TIs, i.e.,

$${X}_{k}^{t , n} s ,$$

are generated from Xₖ∈Cₖ with considering the maximal common exhibition period of itemset Xₖ where MCP(Iₖ)=(t,n). After that from step 23 to step 25 we generate all corresponding temporal sub-itemsets of

$${X}_{k}^{t , n} ,$$

i.e.,

$$SI ( {X}_{k}^{t , n} ) ,$$

to join into CF.

Then from Step 26 to Step 33 of Sub-procedure III we begin the second database scan to calculate the support of each itemset in CF and t find out which candidate itemsets are really frequent TIs and SIs in database D. As a result, those itemsets whose

$${X}_{k}^{t , n} .$$

count≧┌s*|db^{t,nn}|┐ are the frequent temporal itemsets Lₖs.

Finally, in sub-procedure IV, we have to prune out those redundant frequent SIs and TI itemsets are not frequent in database D from the Lₖs. The output of the first algorithm consists of frequent itemsets Lₖs of database D. According to these output Lₖs in Step 38, all kinds of general temporal association rules implied in database D can be generated in a straightforward method.

Note that the first algorithm is able to filter out false candidate itemsets in Pₗ with a hash table. Same as in [26] using a hash table to prune candidate 2-itemsets, i.e., C₂ in each accumulative ongoing partition set Pᵢ of transaction database, the CPU and memory overhead of algorithm can be further reduced. The first algorithm provides very efficient solutions for mining general temporal association rules. This feature is, as described earlier is very important for mining the publication-like databases whose data are being exhibited from different starting times. In addition, the progressive screen produced in each processing phase constitutes the key component to realize the mining of general temporal association rules. Note that the first algorithm proposed has several important advantages, including with judiciously employing progressive knowledge in the previous phases, the algorithm is able to reduce the amount of candidate itemsets efficiently which in turn reduces the CPU and memory overhead; and owing to the small number of candidate sets generated, the scan reduction technique can be applied efficiently. As a result, only two scan of the time series database is required.

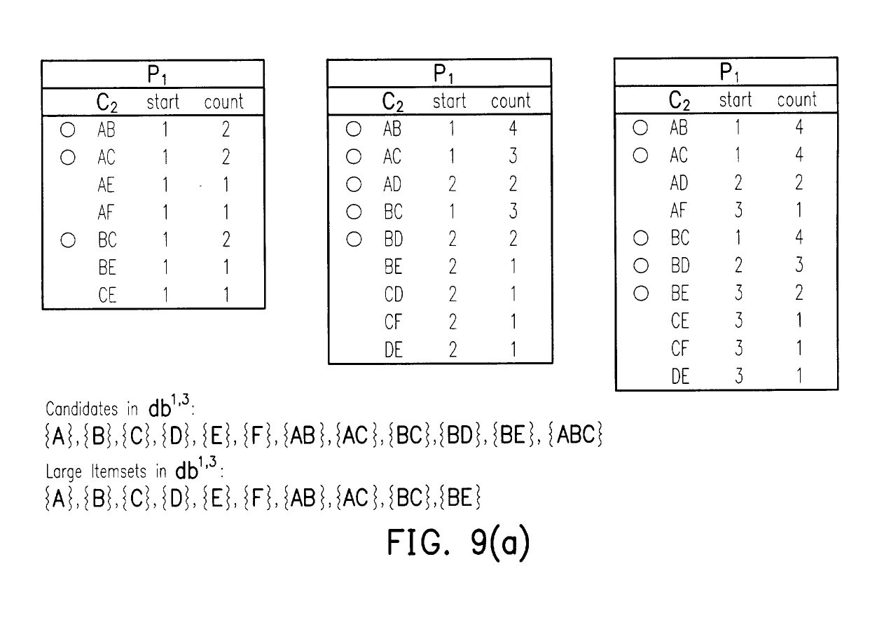

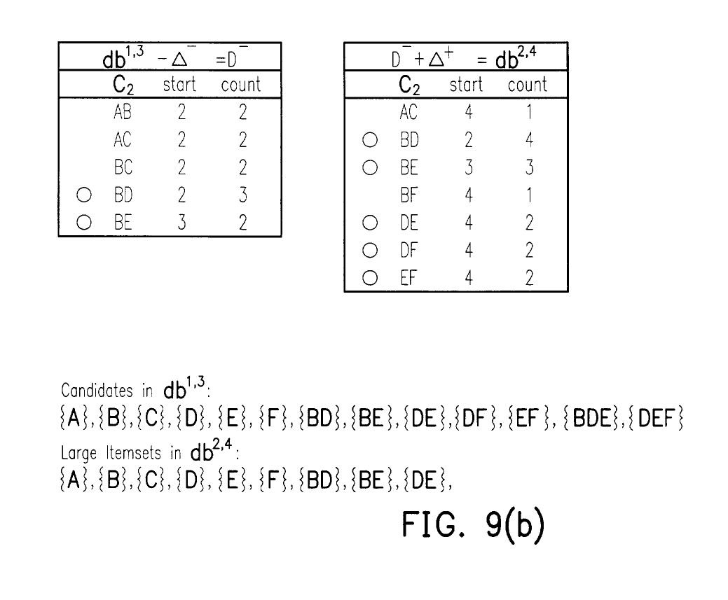

A second algorithm for incremental mining of association rules is also formed on the basis of the pre-processing algorithm. The second algorithm effectively controls memory utilization by the technique of sliding-window partition. More importantly, the second algorithm is particularly powerful for efficient incremental mining for an ongoing time-variant transaction database. Incremental mining is increasing used for record-based databases whose data are being continuously added. Examples of such applications include Web log records, stock market data, grocery sales data, transactions in electronic commerce, and daily weather/traffic. Incremental mining can be decomposed into two procedures: a Preprocessing procedure for mining on the original transaction database, and an Incremental procedure for updating the frequent itemsets for an ongoing time-variant transaction database. The preprocessing procedure is only utilized for the initial mining of association rules in the original database, e.g., db^{1,n}. For the generation of mining association rules in db^{2,n+1}, db^{3,n+2}, db^{l,j}, and so on, the incremental procedure is employed. Consider the database in FIG. 8. Assume that the original transaction database db^{1,3} is segmented into three partitions, i.e. {P₁, P₂, P₃}, in the preprocessing procedure. Each partition is scanned sequentially for the generation of candidate 2-itemsets in the first scan of the database db^{1,3}. After scanning the first segment of 3 transactions, i.e., partition P₁, 2-itemsets {AB, AC, AE, AF, BC, BE, CE} are generated as shown in FIG. 9a. In addition, each potential candidate itemset c∈C₂ has two attributes: c.start which contains the identity of the starting partition when c was added to C₂, and c.count which contains the number of occurrences of c since c was added to C₂. Since there are three transactions in P₁, the partial minimal support is ┌3*0.4┐=2. Such a partial minimal support is called the filtering threshold in this paper. Itemsets whose occurrence counts are below the filtering threshold are removed. Then, as shown in FIG. 9a, only {AB, AB, BC}, marked by “O”, remain as candidate itemsets (of type β in this phase since they are newly generated) whose information is then carried over to the next phase of processing.

Similarly, after scanning partition P₂, the occurrence counts of potential candidate 2-itemsets are recorded (of type α and type β). From FIG. 9a, it is noted that since there are also 3 transactions in P₂, the filtering threshold of those itemsets carried out from the previous phase (that become type α candidate itemsets in this phase) is ┌(3+3)*0.4┐=3 and that of newly identified candidate itemsets (i.e., type β candidate itemsets) is ┌3*0.4┐=2. It can be seen from FIG. 9a that we have 5 candidate itemsets in C₂ after the processing of partition P₂, and 3 of them are type α and 2 of them are type β.

Finally, partition P₃ is processed by the second algorithm. The resulting candidate 2-itemsets are C₂={AB, AC, BC, BD, BE} as shown in FIG. 9a. Note that though appearing in the previous phase P₂ itemset {AD} is removed from Cₛ once P₃ is taken into account since its occurrence count does not meet the filtering threshold then, i.e. 2<3. However, we do have one new itemset, i.e., BE, which joins the C₂ as a type β candidate itemset. Consequently, we have 5 candidate 2-itemsets generated by the second algorithm, and 4 of them are of type α and one of them is of type β.

After generating C₂ from the first scan of database db^{1,3}, we employ the scan reduction technique and use C₂ to generate Cₖ (k=2, 3, . . . , n), where Cₙ is the candidate 3-itemsets and its sequential

$${C}_{k - 1}^{′}$$

can be utilized to generate Cₖ′. Clearly, a C₃′ generated from C₂*C₂ instead of from L₂*L₂, will have a size greater than |C₃| where C₃ is generated from L₂*L₂. However, since the |C₂| generated by the second algorithm is very close to the theoretical minimum, i.e. |L₂|, the |C₃′| is not much larger than |C₃|. Similarly, the |Cₖ′| to close to |Cₖ|. All Cₖ′ can be stored in main memory, and we can find Lₖ (k=1, 2, . . . , n) together when the second scan of the database db^{1,3} is performed. Thus, only two scans of the original database db^{1,3} are required in the preprocessing step. In addition, instead of recording all L_{kS} in main memory, we only have to keep C₂ in main memory for the subsequent incremental mining of an ongoing time variant transaction database.

The merit of the second algorithm mainly lies in its incremental procedure. As depicted in FIG. 9b, the mining database will be moved from db^{1,3} to db^{2,4}. Thus, some transactions, i.e., t₁, t₂, and t₃ are deleted from the mining database and other transactions, i.e., t₁₀, t₁₁, and t₁₂, are added. For ease of exposition, this incremental step can also be divided into three sub-steps: (1) generating C₂ in D⁻=db^{1,3}−Δ⁻, (2) generating C₂ in db^{2,4}=D⁻+Δ⁺ and (3) scanning the database db^{2,4} only once for the generation of all frequent itemsets Lₖ. In the first sub-step db^{1,3}−Δ⁻=D⁻, we check out the pruned partition P₁ and reduce the value of c.count and set c.start=2 for those candidate itemsets c where c.start=1. It can be seen that itemsets {AB, AC, BC} were removed. Next, in the second sub-step, we scan the incremental transactions in P₄ as type β candidate itemsets. Finally, in the third sub-step, we use C₂ to generate Cₖ′ as mentioned above. With scanning db^{2,4} only once, the second algorithm obtains frequent itemsets {A, B, C, D, E, F, BD, BE, DE} in db^{2,4}. The improvement achieved by the second algorithm is even more prominent as the amount of the incremental portion increases and also as the size of the database db^{l,j} increases.

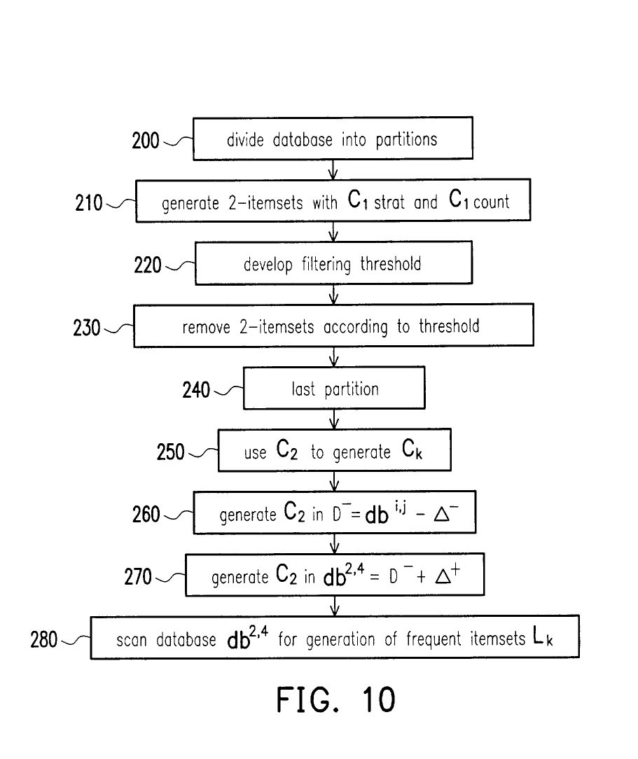

The second algorithm is illustrated in the flowchart of FIG. 10 and shown below wherein:

db^{1,n}=The partial database of D formed by a continuous region from Pₗ to Pₙ

s=Minimum support required

|Pₖ|=Number of transactions in partition Pₖ

Nₚₖ(I)=Number of transactions in partition Pₖ that contain itemset I

|db^{1,n}(I)|=Number of transactions in db^{1,n} that contain itemset I

C^{l,j}=The set of progressive candidate itemsets generated by database db^{l,j}

Δ⁻=The deleted portion of an ongoing transaction database

D⁻=The unchanged portion of an ongoing transaction database

Δ⁺=The added portion of an ongoing transaction database

Preprocessing procedure of the second algorithm:

1. n=Number of partitions;

$$2. \vert {db}^{1 , n} \vert = {\sum }_{k = 1 , n}^{} \vert {P}_{k} \vert ;$$

3 CF=0;

4. begin for k=1 to n //1^{st} scan of db^{1,n}

5. begin for each 2-itemset I∈Pₖ

6. if (I∈CF)

7. I.count=Nₚₖ(I);

8. I.start=k;

9. if (I.count≧s*|Pₖ|)

10. CF=CF∪I;

11. if (I∈CF)

12. I.count=I.count+Nₚₖ(I);

$$13. if ( I \cdot count < ⌈ s * {\sum }_{m = I \cdot start , k}^{} \vert {P}_{m} \vert ⌉ )$$

14. CF=CF−I;

15. end

16. end

17. select

$${C}_{2}^{1 , n}$$

from I where I∈CF

18. keep

$${C}_{2}^{1 , n}$$

in main memory;

19. h=2; //C₁ is given

20. begin while

$$( {C}_{h}^{1 , n} \neq 0 )$$

//Database scan reduction

$$21. {C}_{h + 1}^{1 , n} = {C}_{h}^{1 , n} * {C}_{h}^{1 , n} ;$$

22 h=h+1;

23. end

24. refresh I.count=0 where

$$I ∈ {C}_{h}^{1 , n} ;$$

25. begin for k=1 to n //2^{nd} scan of db^{1,n}

26. for each itemset

$$I ∈ {C}_{h}^{1 , n}$$

27. I count=I.count+Nₚₖ(I);

28. end

29. for each itemset

$$I ∈ {C}_{h}^{1 , n}$$

30. if (I.count≧┌s*|db^{1,n}|┐)

31. Lₕ=Lₕ∪I;

32. end

33. return Lₕ;

Incremental procedure of the second algorithm:

1. Original database=db^{m,n};

2. New database=db^{l,j};

3. Database removed

$${Δ}^{-} = {\sum }_{k = m , i - 1} {P}_{k} ;$$

4. Database database

$${Δ}^{+} = {\sum }_{k = n + 1 , j} {P}_{k} ;$$

$$5. {D}^{-} = {\sum }_{k = i , n} {P}_{k}$$

6. db^{l,j}=db^{m,n}−Δ⁻+Δ⁺;

7. loading

$${C}_{2}^{m , n}$$

of db^{m,n} into CF where

$$I ∈ {C}_{2}^{m , n}$$

8. begin for k=m to i−1//one scan of Δ⁻

9. begin for each 2-itemset I∈Pₖ

10. if (I∈CF and I.start≦k)

11. I.count=I.count−Nₚₖ(I);

12. I.start=k+1;

$$13. if ( I \cdot count < ⌈ s * {\sum }_{m = I \cdot start , n} \vert {P}_{m} \vert ⌉$$

14. CF=CF−1;

15. end

16. end

17. begin for k=n+1 to j //one scan of Δ⁺

18. begin for each 2-itemset I∈Pₖ

19. if (I∉CF)

20. I.count=Nₚₖ(I);

21. I.start=k;

22. if (I.count≧s*|Pₖ|)

23. CF=CF∪I;

24. if (I∈CF)

25. I.count=I.count+Nₚₖ(I);

$$26. if ( I \cdot count < ⌈ s * {\sum }_{m = I \cdot start , k} \vert {P}_{m} \vert$$

27. CF=CF−1;

28. end

29. end

30. select

$${C}_{2}^{i , j}$$

from I where I∈CF;

31. keep

$${C}_{2}^{i , j}$$

in main memory;

32. h=2//C₁ is well known.

33. Begin while

$$( {C}_{h}^{i , j} \neq 0 )$$

//Database scan reduction

$${C}_{h + 1}^{i , j} = {C}_{h}^{i , j} * {C}_{h}^{i , j} ;$$

35. h=h+1;

36. end.

37. Refresh I.count=0 where

$$I ∈ {C}_{h}^{i , j} ;$$

38. begin for k=i to j //only one scan of db^{l,j}

39. for each itemset

$$I ∈ {C}_{h}^{i , j}$$

40. I.count=I.count+Nₚₖ(I);

41 end

42. for each itemset

$$I ∈ {C}_{h}^{i , j}$$

43. if (I.count≧┌s*|db^{l,j}|┐)

44. Lₕ=Lₕ∪I;

45. end

46. return Lₕ;

The preprocessing procedure of the second algorithm is outlined below. Initially, the database db^{1,n} is partitioned into n partitions by executing the preprocessing procedure (in Step 2), and CF, i.e. cumulative filter, is empty (in Step 3). Let

$${C}_{2}^{i , j}$$

be the set of progressive candidate 2-itemsets generated by database db^{l,j}. It is noted that instead of keeping Lₖₛ in the main memory, the second algorithm only records

$${C}_{2}^{1 , n}$$

which is generated by the preprocessing procedure to be used by the incremental procedure.

From Step 4 to Step 16, the algorithm processes one partition at a time for all partitions. When partition Pₗ is processed, each potential candidate 2-itemset is read and saved to CF. The number of occurrences of an itemset I and its starting partition are recorded in I.count and I.start, respectively. An itemset, whose I.count≧

$$⌈ s * {\sum }_{m = I . start , k} \vert {P}_{m} \vert ⌉ ,$$

will be kept in CF. Next, we select

$${C}_{2}^{1 , n}$$

from I where I∈CF and keep

$${C}_{2}^{1 , n}$$

in main memory for the subsequent incremental procedure. With employing the scan reduction technique from Step 19 to Step 23,

$${C}_{h}^{1 , n} s ( h \geq 3 )$$

are generated in main memory. After refreshing I.count=0 where

$$I ∈ {C}_{h}^{1 , n} ,$$

we begin the last scan of database for the preprocessing procedure from Step 25 to Step 28. Finally, those itemsets whose I.count≧┌s*|db^{1,n}|┐ are the frequent itemsets.

In the incremental procedure of the second algorithm, D⁻ indicates the unchanged portion of an ongoing transaction database. The deleted and added portions of an ongoing transaction database are denoted by Δ⁻ and Δ⁺, respectively. It is worth mentioning that the sizes of Δ⁻ and Δ⁺, i.e. |Δ⁺| and |Δ⁻| respectively, are not required to be the same. The incremental procedure of the algorithm is devised to maintain frequent itemsets efficiently and effectively. The incremental step can be divided into three sub-steps: (1) generating C₂ in D⁻=db^{1,3}−Δ⁻, (2) generating C₂ in db^{2,4}=D⁻+Δ⁺ and (3) scanning the database db^{2,4} only once for the generation of all frequent itemsets Lₖ. Initially, after some update activities, old transactions Δ⁻ are removed from the database db^{m,n} and new transactions Δ⁺ are added (in step 6). Note that Δ⁻⊂db^{m,n}. Denote the updated database as db^{l,j}. Note that db^{l,j}=db^{m,n}−Δ⁻+Δ⁺. We denote the unchanged transactions by D⁻=db^{m,n}−Δ⁻=db^{i,j}−Δ⁺. After loading

$${C}_{2}^{m , n}$$

of db^{m,n} into CF where

$$I ∈ {C}_{2}^{m , n} ,$$

we start the first sub-step, i.e., generating C₂ in D⁻=db^{m,n}−Δ⁻. This sub-step tries to reverse the cumulative processing which is described in the preprocessing procedure. From Step 8 to Step 16, we prune the occurrences of an itemset I, which appeared before partition Pₗ, by deleting the value I.count where I∈CF and I.start<i. Next, from Step 17 to Step 36, similarly to the cumulative processing Section 3.2.1, the second sub-step generates new potential

$${C}_{2}^{i , j}$$

in db^{l,j}=D⁻+Δ⁺ and employs the scan reduction technique to generate

$${C}_{h}^{i , j} s$$

from

$${C}_{2}^{i , j} .$$

Finally, to generate new L_{kS} in the updated database, we scan db^{l,j} for only once in the incremental procedure to maintain frequent itemsets. Note that

$${C}_{2}^{i , j}$$

is kept in main memory for the next generation of incremental mining.

Note that the second algorithm is able to filter out false candidate itemsets in Pₗ with a hash table. Same as in [24], using a hash table to prune candidate 2-itemsets, i.e., C₂, in each accumulative ongoing partition set Pₗ of transaction database, the CPU and memory overhead of the algorithm can be further reduced. The second algorithm provides an efficient solution for incremental mining, which is important for the mining of record-based databases whose data are frequently and continuously added, such as web log records, stock market data, grocery sales data, and transactions in electronic commerce, to name a few.

The third algorithm based on the pre-processing algorithm regards weighted association rules in a time-variant database. In the third algorithm, the importance of each transaction period is first reflected by proper weight assigned by the user. Then, the algorithm partitions the time-variant database in light of weighted periods of transactions and performs weighted mining. The third algorithm first partitions the transaction database in light of weighted periods of transactions and then progressively accumulates the occurrence count of each candidate 2-itemset based on the intrinsic partitioning characteristics. With this design, the algorithm is able to efficiently produce weighted association rules for applications where different time periods are assigned with different weights. The algorithm is also designed to employ a filtering threshold in each partition to early prune out those cumulatively infrequent 2-itemsets. The feature that the number of candidate 2-itemsets generated by function W (□) in the weighted period Pₗ of the database D. Formally, we have the following definitions:

In the first definition let N_{Pl}(X) be the number of transactions in partition Pₗ that contain itemset X. Consequently, the weighted support value of an itemset X can be formulated as

$${S}^{W} ( X ) = \sum {N}_{Pi} ( X ) \times W ( {P}_{i} ) .$$

As a result, the weighted support ratio of an itemset X is supp^{W}

$$( X ) = \frac{{S}^{W} ( X )}{Σ \vert {P}_{i} \vert \times W ( {P}_{i} )} \cdot$$

In accordance with the first definition, an itemset X is termed to be frequent when the weighted occurrence frequency of X is larger than the value of min-supp required, i.e., supp^{W} (X)>min_supp, in transaction set D. The weighted confidence of a weighted association rule (X [symbol] y)^{W} is then defined below.

In the second definition conf^{W}

$$( X ⇒ Y ) = \frac{sup {p}^{W} ( X ⋃ Y )}{sup {p}^{W} ( X )} .$$

In the third definition an association rule X [symbol] Y is termed a frequent weighted association rule (X [symbol] y)^{W} if and only if its weighted support is larger than minimum support required, i.e., supp^{W}(XuY)>min_supp, and the weighted confidence conf^{W} (X [symbol] Y) is larger than minimum confidence needed, i.e., conf^{W} (X [symbol] Y)>min_conf Explicitly, the third algorithm explores the mining of weighted association rules, denoted by (X [symbol] Y)^{W}, which is produced by two newly defined concepts of weighted-support and weighted-confidence in light of the corresponding weights in individual transactions. Basically, an association rule X [symbol] Y is termed to be a frequent weighted association rule (X [symbol] Y)^{W} if and only if its weighted support is larger than minimum support required, i.e., supp^{W}(X∪Y)>min_conf. Instead of using the traditional support threshold min_S^{T}=┌|D|×min_sup p┐ as a minimum support threshold for each item, a weighted minimum support, denoted by min

$${min\_S}^{W} = \{ Σ \vert {P}_{i} \vert \times W ( {P}_{i} ) \} \times min\_sup p ,$$

is employed for the mining of weighted associatio rules, where

$$\vert {P}_{i} \vert$$

and W(Pₗ) represent the amount of partial transactions and their corresponding weight values by a weighted function W(·) in the weighted period Pi of the database D. Let Nₚₗ(X) be the number of transactions in partition Pi that contain itemset X. The support value of an itemset X can then be formulated as

$${S}^{W} ( X ) = \sum {N}_{Pi} ( X ) \times W ( {P}_{i} ) .$$

As a result, the weighted support ration of an itemset X is supp^{W}

$$( X ) = \frac{{S}^{W} ( X )}{Σ \vert {P}_{i} \vert \times W ( {P}_{i} )} \cdot$$

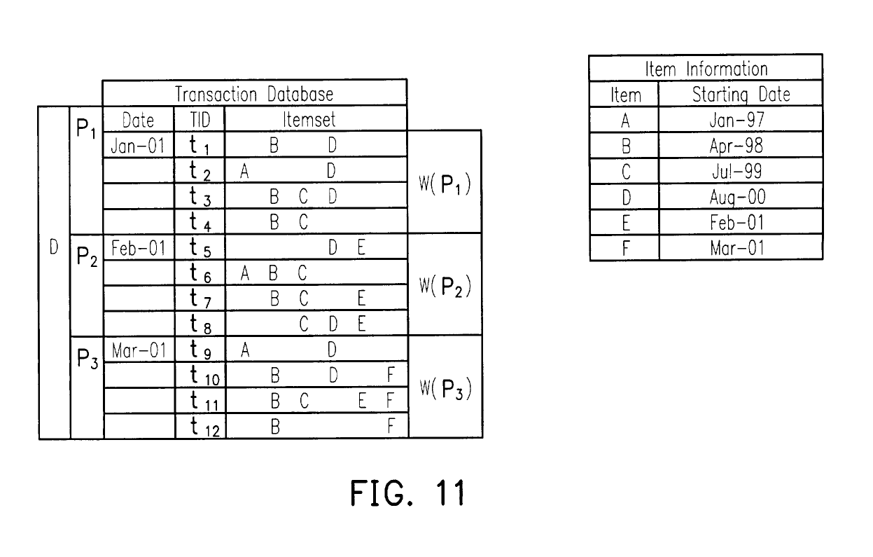

Looking at FIG. 11, the minimum transaction support and confidence are assumed to be min_supp=30% and min_conf=75%, respectively. A set of time-variant database indicates the transaction records from January 2001 to March 2001. The starting date of each transaction item is also given. Based on traditional mining techniques, the support threshold is denoted as min_S^{T}=┌2×0.3┐=4 where 12 is the size of tranaction set D. It can be seen that only {B, C, D, E, BC} can be termed as frequent itemsets since their occurences in this transaction database are all larger than the value of support threshold min_S^{T}. Thus, rule C [symbol] B is termed as a frequent association rule with support supp (C∪B)=41.67% and confidence conf(C [symbol] B)=83.33%. If we assign weights wherein W(P₁)=0.5, W(P₂)=1, and W(P₃)=2, we have this newly defined support threshold as min_S^{W}={4×0.5+4×1+4×2}×0.3=4.2, we have weighted association rules, i.e., (C [symbol] B)^{W} with relative weighted support supp^{w} (C∪B)=35.7% and confidence

$${conf}^{W} ( C ⇒ B ) = \frac{sup {p}^{W} ( C ⋃ B )}{sup {p}^{W} ( C )} = 83.3 \% and {( F ⇒ B )}^{W}$$

with relative weighted support supp^{W} (F∪B)=42.8% and confidence

$${conf}^{W} ( F ⇒ B ) = \frac{sup {p}^{W} ( F ⋃ B )}{sup {p}^{W} ( F )} = 100 \% .$$

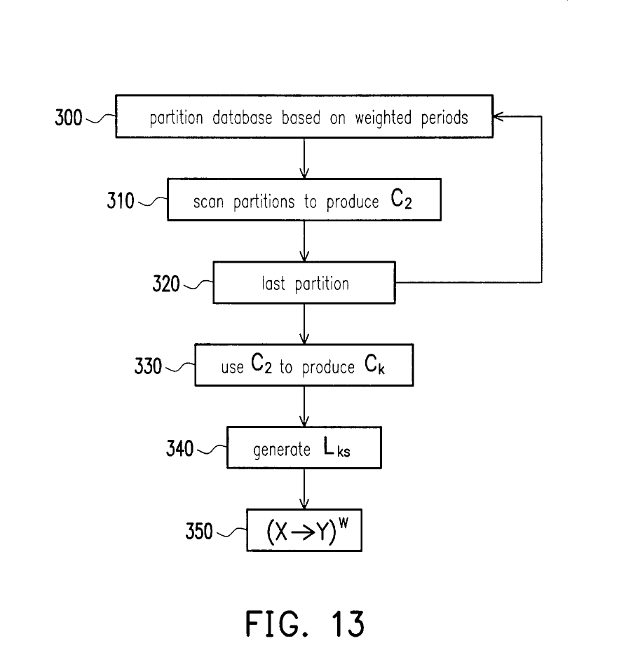

Initially, a time-variant database D is partitioned into n partitions based on the weighted periods of transactions. The algorithm is illustrated in the flowchart in FIG. 13 and is further outlined below, where algorithm is decomposed into four sub-procedures for ease of description. C₂ is the set of progressive candidate 2-itemsets generated by database D. Recall that N_{Pl}(X) is the number of transactions in partition Pₗ that contain itemset X and W(Pₗ) is the corresponding weight of partition Pₗ.

Procedure 1: Initial Partition

1. |D|=Σ_{l=1,n}|Pₗ|;

Procedure 2: Candidate 2-Itemset Generation

2. begin for i=1 to n //1^{st} scan of D

3. begin for each 2-itemset X₂∈Pₗ

4. if (X₂∉C₂)

5. X₂.count=N_{Pl}(X₂)×W(Pi);

6. X₂.start=h;

7. if (X₂.count≧min_supp×|Pₗ|×W(Pₗ))

8. C₂=C₂∪X₂;

9. if (X₂∈C₂)

10. X₂.count=X₂.count+N_{Pl}(X₂)×W(Pₗ);

11. if (X₂.count<min_supp×Σ_{m=X}_{₂} _{start,l}(|Pₘ|×W(Pₘ)))

12. C₂=C₂−X₂;

13. end

14. end

Procedure 3: Candidate k-itemset Generation

15. begin while (Cₖ≠0 & k≧2)

16. Cₖ₊₁=Cₖ*Cₖ;

17. k=k+1;

18. end

Procedure 4: Frequent Itemset Generation

19. begin for i=1 to n

20. begin for each itemset Xₖ∈Cₖ

21. Xₖ.count=Xₖ.count+N_{Pl}(Xₖ)×W(Pₗ);

22. end

23. begin for each itemset Xₖ∈Cₖ

24. if

$$( {X}_{k} . count \geq min\_supp \times {\sum }_{m = 1 , n} ( \vert {P}_{m} \vert \times W ( {P}_{m} ) ) )$$

25. Lₖ=Lₖ∪Xₖ;

26. end

27. return Lₖ;

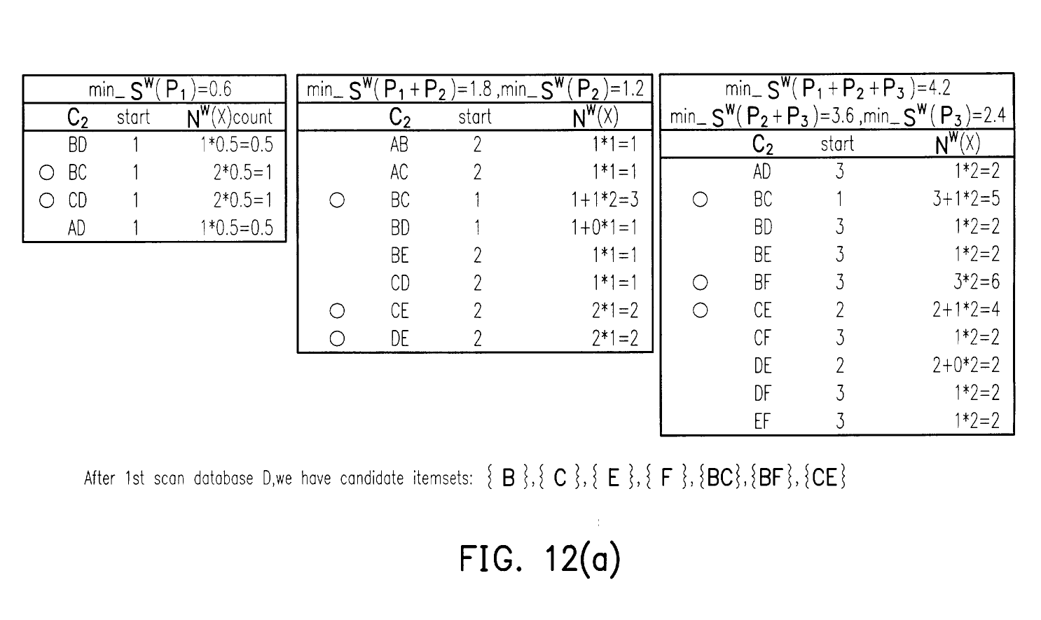

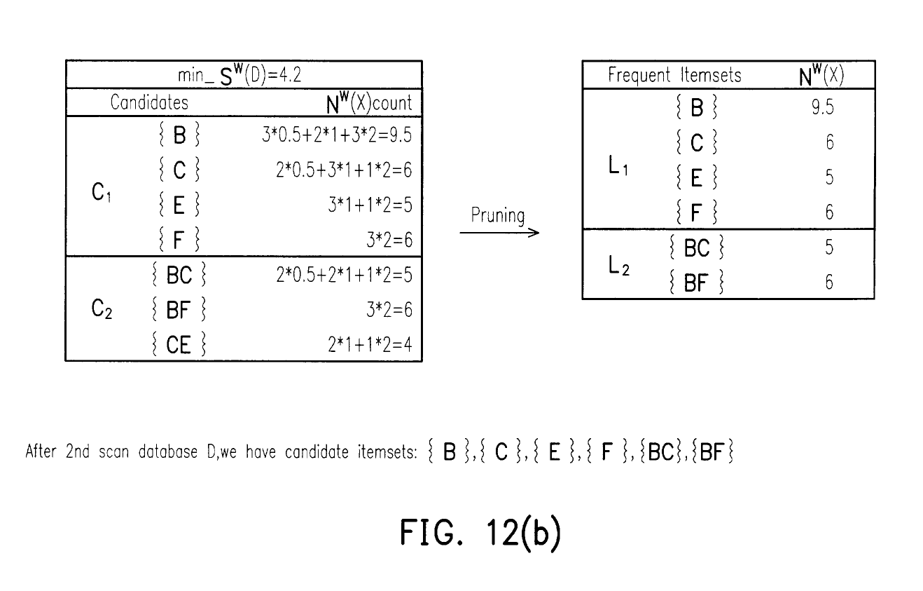

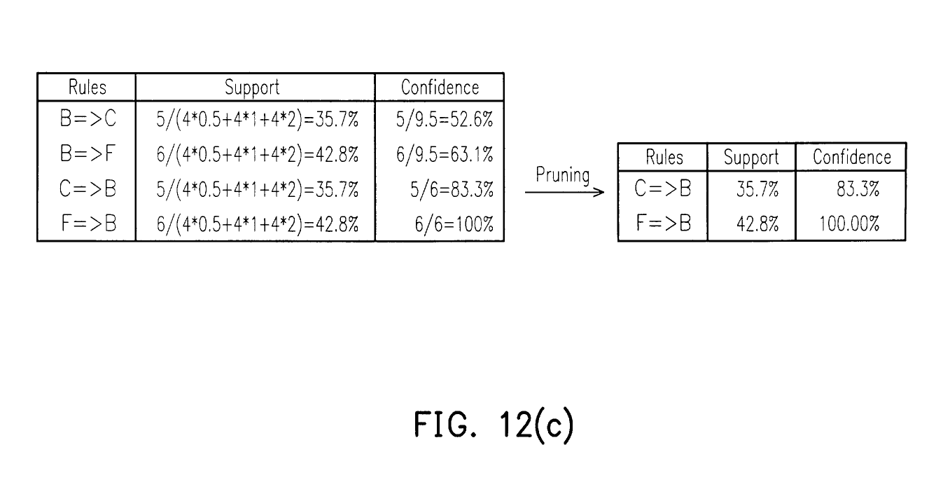

Since there are four transactions in P₁, the partial weighted minimal support is min_S^{W}(P₁)=4×0.3×0.5=0.6. Such a partial weighted minimal support is called the filtering threshold. Itemsets whose occurrence counts are below the filtering threshold are removed. Then, as shown in FIG. 12a, only {BD,BC}, marked by “O”, remain as candidate itemsets (of type B in this phase since they are newly generated) whose information is then carried over to the next phase P₂ of processing.

Similarly, after scanning partition P₂, the occurrence counts of potential candidate 2-itemsets are recorded (of type α and type B). From FIG. 12a, it is noted that since there are also 4 transactions in P₂, the filtering threshold of these itemsets carried out from the previous phase (that become type α candidate itemsets in this phase) is min_S^{W}(P₁+P₂)=4×0.3×0.5+4×0.3×1=1.8 and that of newly identified candidate itemsets (i.e., type B candidate itemsets) is min_S^{W}(P₂)=4×0.3×1=1.2. It can be seen in FIG. 12b that we have 3 candidate itemsets in C₂ after the processing of partition P₂, and one of them is of type α and two of them are of type B.

Finally, partition P₃ is processed by the third algorithm. The resulting candidate 2-itemsets are C₂={BC, CE, BF} as shown in FIG. 12b. Note that though appearing in the previous phase P₂, itemset {DE} is removed from C₂ once P₃ is taken into account since its occurrence count does not met the filtering threshold then, i.e. 2<3.6. However, we do have one new itemset, i.e. {BF}, which joins the C₂ as a type B candidate itemset. Consequently, we have 3 candidate 2-itemsets generated by the third algorithm and two of them are of type α and one of them is of type B. Note that only 3 candidate 2-itemsets are generated by the third algorithm.

After generating C₂ from the first scan of database D, we employ the scan reduction technique.

In essence, the region ration of an itemset is the support of that itemset if only the part of transaction database db^{l,j} is considered.

Lemma 1: A 2-itemset X₂ remains in the C₂ after the processing of partition Pⱼ if and only if there exists an i such that for any integer t in the interval [i,j],r_{l,t}(X₂)≧min_S^{W}(db^{l,t}), where min_S^{W}(db^{l,j}) is the minimal weighted support required.

Lemma 1 leads to Lemma 2 below.

Lemma 2: An itemset X₂ remains in C₂ after the processing of parition Pⱼ if and only if there exists an i such that r_{l,j}(X₂)≧min_S^{W}(db^{l,j}), where min_S^{W}(db^{l,j}) is the minimal support required

Lemma 2 leads to the following theorem which states the correctness of algorithm PWM.

Theorem 1: If an itemset X is a frequent itemset, then X will be in the candidate set of itemsets produced by algorithm PWM.

It follows from Theorem 1 that when W (□)=1, the frequent itemsets generated by the third algorithm will be the same as those produced by the association rule mining algorithms.

Various additional modifications may be made to the illustrated embodiments without departing from the spirit and scope of the invention. Therefore, the invention lies in the claims hereinafter appended.

What is claimed is:

1. A pre-processing method for data mining, comprising:
dividing a database into a plurality of partitions;
scanning a first partition for generating a plurality of candidate itemsets;
developing a filtering threshold based on each partition and removing the undesired candidate itemsets; and
scanning a second partition while taking into consideration the desired candidate itemsets from the first partition.

2. The method of claim 1, wherein the generation of candidate itemsets includes the steps of:
assigning a candidate itemset a value of when an itemset was added to an accumulator; and
adding a value for the number of occurrences of the itemset from the point the itemset to the accumulator.

3. The method of claim 1, wherein the step of removing the undesired candidate itemsets is based on a minimum threshold requirement as defined by the filtering threshold.

4. A method for mining general temporal association rules, comprising:
dividing a database into a plurality of partitions including a first partition and a second partition;
scanning the first partition for generating candidate itemsets;
developing a filtering threshold based on the scanned first partition and removing the undesired candidate itemsets;
scanning the second partition while taking into consideration the desired candidate itemsets from the first partition;
performing a scan reduction process by considering an exhibition period of each candidate itemset;
scanning the database to determine the support of each of the candidate itemsets in the filtering threshold; and
pruning out redundant candidate itemsets that are not frequent in the database and outputting the final itemsets.

5. The method of claim 4, wherein the generation of candidate itemsets includes the step of assigning a candidate itemset a value of when an itemset was added to an accumulator and adding a value for the number of occurrences of the itemset from the point the itemset to the accumulator.

6. The method of claim 4, wherein the removal of undesired candidate itemsets is based on a minimum threshold requirement as defined by the filtering threshold.

7. A method for incremental mining comprising:
dividing a database into a plurality of partitions, including a first partition and a second partition;
scanning the first partition for generating a plurality of candidate itemsets;
developing a filtering threshold based on each of the partitions and removing undesired candidate itemsets of the candidate itemsets;
removing transactions from the candidate itemset based on a previous partition; and
adding transactions to the itemset based on a next partition.

8. The method of claim 6, wherein the generation of the candidate itemsets includes the step of assigning a candidate itemset a value of when an itemset was added to an accumulator, and adding a value for the number of occurrences of the itemset from the point the itemset to the accumulator.

9. The method of claim 6, wherein the removal of the undesired candidate itemsets is based on a minimum threshold requirement as defined by the filtering threshold.
